SEQUENCE LISTING (12 sequences)

SEQ ID NO: 1 - protein, 25 aa, synthetic construct
  REGION 1..25: note = Peptide 1
DKCLKFYSKISEYRHYCYSLYGTTL

SEQ ID NO: 2 - protein, 35 aa, synthetic construct
  REGION 1..35: note = Peptide 2
LYCYEQLNDSSEEEDEIDGPAGQAEPDRAHYNIVT

SEQ ID NO: 3 - protein, 35 aa, synthetic construct
  REGION 1..35: note = Peptide 3
MHGDTPTLHEYMLDLQPETTDLYCYEQLNDSSEEE

SEQ ID NO: 4 - protein, 32 aa, synthetic construct
  REGION 1..32: note = Peptide 4
RCINCQKPLCPEEKQRHLDKKQRFHNIRGRWT

SEQ ID NO: 5 - protein, 35 aa, synthetic construct
  REGION 1..35: note = Peptide 5
TLRLCVQSTHVDIRTLEDLLMGTLGIVCPICSQKP

SEQ ID NO: 6 - protein, 32 aa, synthetic construct
  REGION 1..32: note = Peptide 6
DKKQRFHNIRGRWTGRCMSCCRSSRTRRETQL

SEQ ID NO: 7 - protein, 25 aa, synthetic construct
  REGION 1..25: note = Peptide 7
HYCYSLYGTTLEQQYNKPLCDLLIR

SEQ ID NO: 8 - protein, 25 aa, synthetic construct
  REGION 1..25: note = Peptide 8
KQQLLRREVYDFAFRDLCIVYRDGN

SEQ ID NO: 9 - protein, 32 aa, synthetic construct
  REGION 1..32: note = Peptide 9
LPQLCTELQTTIHDIILECVYCKQQLLRREVY

SEQ ID NO: 10 - protein, 30 aa, synthetic construct
  REGION 1..30: note = Peptide 10
MHQKRTAMFQQERPRKLPQLCTELQTTIHD

SEQ ID NO: 11 - protein, 26 aa, synthetic construct
  REGION 1..26: note = Peptide 11
RDLCIVYRDGNPYAVCDKCLKFYSKI

SEQ ID NO: 12 - protein, 32 aa, synthetic construct
  REGION 1..32: note = Peptide 12
YGTTLEQQYNKPLCDLLIRCINCQKPLCPEEK

(19) United States
(12) Patent Application Publication
(10) Pub. No.: US 2023/0296569 A1
(43) Pub. Date: Sep. 21, 2023

(54) Substance quantification in complex mixtures

(71) Applicant: ISA Pharmaceuticals B.V., Oegstgeest (NL)

(72) Inventors: Brigitte Elisa Anna Burm, Oegstgeest (NL); Thomas Johannes Maria Beenakker, Oegstgeest (NL)

(73) Assignee: ISA Pharmaceuticals B.V., Oegstgeest (NL)

(21) Appl. No.: 18/152,192

(22) Filed: Jan. 10, 2023

Related U.S. Application Data
(63) Continuation of application No. PCT/EP2022/069372, filed on Jul. 12, 2022.

(30) Foreign Application Priority Data
Jul. 12, 2021 (EP) 21185031.8

(51) Int. Cl. G01N 30/02

(52) U.S. Cl. CPC G01N 30/02; G01N 2030/027; G01N 2030/047

(57) ABSTRACT

The disclosed invention is in the field of analytical chemistry. In particular, it relates to methods for improved quantification of analytes in complex mixtures, and to compositions comprising precise amounts of said analytes. The improved method uses stable reference standards.

### REFERENCE TO AN ELECTRONIC SEQUENCE LISTING

The contents of the electronic sequence listing (P6094839PCT wiposequence St26.xml.; Size: 16KB; and Date of Creation: Jan. 10, 2023) is herein incorporated by reference in its entirety.

### FIELD

The disclosed invention is in the field of analytical chemistry. In particular, it relates to methods for improved quantification of analytes in complex mixtures, and to compositions comprising precise amounts of said analytes. The improved method uses stable reference standards.

### BACKGROUND

Accurate identification and quantification of a drug substance in a drug product is of interest, particularly to the pharmaceutical industry. Especially in complex mixtures comprising multiple drug substances, it is technically demanding to ensure that the drug product meets its required specifications. Such specifications describe the required content of each substance and can also describe the maximum allowed content of any impurities. Specifications can be regulatory precautions, and help ensure that the drug product may be vital for its efficacy and safety.

Conventional quantification of drug substances and impurities in a drug product relies on chromatographic methods using reference standards. Such standards comprise the same drug substance in a known quantity. These methods have drawbacks which can decrease their accuracy. For instance, many drug substances are hygroscopic, which complicates the preparation of reference standards comprising accurate concentrations of said substances. Further, the preparation of fresh reference standard prior to each measurement is typically required because standards in solution can have a stability that is lower than what is required of a reliable measurement standard. The continuous need for standard preparation is cumbersome and may decrease reproducibility between different measurements.

The problem is particularly evident for peptide-based drug substances. As is commonly known (see for instance the “Storage and handling synthetic peptides—guidelines” published in 2005 by Sigma-Aldrich Co., and available on the internet at www.sigmaaldrich.com/deepweb/assets/sigmaaldrich/ marketing/global/documents/403/465/peptide_handling_guide.pdf), the shelf life of peptide solutions is limited. Peptides containing various residues such as N, Q, C, M and W are unstable when stored in solution. Using sterile buffers (pH 5-6) and freezing the aliquots will prolong the storage life of the peptide, but this requires frozen storage. Repeated freeze-thaw cycles can degrade the peptides. The most effective way to prevent or minimize peptide degradation is to store the peptide in lyophilized form at −20 ° C. or preferably at −80 ° C. If the peptide is in solution, freeze-thaw cycles should be avoided. Exposure of lyophilized peptides and solutions to atmospheric oxygen should be minimized to avoid the capture of atmospheric moisture, further reducing the reliability of the standard.

In the art, peptide reference standards have been developed that for instance involve the concatenation of the standard peptides into an artificial protein, to improve stability during storage (WO2016150853). This would however require the separate development of large polypeptides for each mixture of products for which a reference standard is desired.

Accordingly, there is a need for improved quantification methods of drug substances in mixtures. In particular, there is a need for improved quantification methods of peptide-based drug substances in peptide drug products. There is a need for analytical methods for quantifying drug substances wherein the requirement of reference standard preparation is obviated. There is a need for analytical methods of complex drug products wherein samples can be stored and handled under less strict conditions, and wherein samples are readily available without requiring further development.

### SUMMARY

An aspect of the invention relates to a method for producing a mixture comprising a known quantity of a first analyte, the method comprising the steps of:
i) providing a mixture comprising the first analyte;
ii) providing a reference standard comprising a known amount of a reference substance, wherein the reference substance is not the first analyte, wherein the reference substance is preferably a small molecule, and wherein the ratio between the molar extinction coefficient of the first analyte and the molar extinction coefficient of the reference substance is known;
iii) determining the absorbance of the first analyte and of the reference substance using spectrophotometry to obtain values for first analyte absorbance and for reference substance absorbance; and
iv) determining the content of the first analyte in the mixture based on the obtained absorbance values and the known ratio of molar extinction coefficients.

In some embodiments, the method of the invention is such that the first analyte is a peptide, preferably a peptide having a length from 5 to 100 amino acids, preferably from 10 to 50 amino acids. In some embodiments, the first analyte is a peptide comprising a sequence represented by any one of SEQ ID NOs: 1-12. In some embodiments, the mixture provided in step i) is a UV-transparent solution. In some embodiments, the mixture provided in step i) comprises the first analyte and solvents, wherein the solvents are preferably selected from water, isopropyl alcohol, and acetonitrile, and wherein optionally an acid is present such as formic acid or trifluoroacetic acid. In some embodiments, the mixture further comprises a second analyte and optionally a third, fourth, fifth, sixth, seventh, eighth, ninth, tenth, eleventh, twelfth, thirteenth, fourteenth, or fifteenth analyte, preferably wherein the ratios between the molar extinction coefficients of each analyte and the molar extinction coefficient of the reference substance are known. In some embodiments, the absorbance of each analyte is determined in step iii), and the content of each analyte is determined in step iv). In some embodiments, step iii) is performed using analytical liquid chromatography, such as HPLC or UPLC, and optionally step iii) comprises the following sub-steps:
iii-a) adding a known amount of reference substance to the mixture;
iii-b) separating the first analyte and the reference substance using liquid chromatography;
iii-c) determining the absorbance of the first analyte and of the reference substance using spectrophotometry to obtain values for first analyte absorbance and for reference substance absorbance.
   In some embodiments, the molar extinction coefficient of a reference substance and/or analyte is the molar extinction coefficient determined at a wavelength from 180 to 800 nm, preferably from 200 to 600 nm, more preferably from 200 to 400 nm such as at 220 nm, 254 nm, or 280 nm. In some embodiments, the reference substance has a molar extinction coefficient of from 0.1·10⁴ L·mol⁻¹·cm⁻¹ to 3·10⁴ L·mol⁻¹·cm⁻¹, preferably of from 0.9·10⁴ L·mol⁻¹·cm⁻¹ to 1.5·10⁴ L·mol⁻¹·cm⁻¹. In some embodiments, the reference standard is a United States Pharmacopeia (USP) reference standard. In some embodiments, the reference standard is a standard comprising caffeine, acetaminophen, sulfadimethoxine, verapamil, reserpine, amitriptyline, naphthalene, butylparaben, uracil, sulfaguanidine, Val-Tyr-Val, leucine-enkephalin, terfenadine, or a salt thereof, preferably comprising caffeine, acetaminophen, sulfadimethoxine, verapamil, reserpine, amitriptyline, naphthalene, butylparaben, uracil, or a salt thereof, more preferably comprising reserpine or a salt thereof.

Another aspect of the invention relates to a composition comprising at least four different peptides, said peptides comprising a sequence represented by any one of SEQ ID NOs: 1-12, wherein the weight percentage of each peptide is from 93% to 103% of the average weight percentage of all different peptides

Another aspect of the invention relates to a plurality of compositions, comprising at least a first composition and a second composition, wherein the first and the second composition are each a composition according to the invention, wherein the compositions differ from each other in that the compositions originate from different production batches, wherein the weight percentage of each peptide comprised in the first composition is from 93% to 103% of the weight percentage of that same peptide as comprised in the second composition, wherein preferably the compositions comprise one of:

DP-5P) five different peptides, each peptide comprising one of SEQ ID NOs: 1-5; or

DP-7P) seven different peptides, each peptide comprising one of SEQ ID NOs: 6-12.

Another aspect of the invention relates to a combination of
i) a composition comprising at least two different peptides, said peptides comprising a sequence represented by any one of SEQ ID NOs: 1-12, and
ii) a reference standard, preferably United States Pharmacopeia (USP) reference standard, or a reference standard comprising caffeine, acetaminophen, sulfadimethoxine, verapamil, reserpine, amitriptyline, naphthalene, butylparaben, uracil, sulfaguanidine, Val-Tyr-Val, leucine-enkephalin, terfenadine, or a salt thereof, preferably comprising caffeine, acetaminophen, sulfadimethoxine, verapamil, reserpine, amitriptyline, naphthalene, butylparaben, uracil, or a salt thereof, more preferably comprising reserpine or a salt thereof.

### Description

The inventors have surprisingly found that analytes in complex mixtures can be quantified with great precision by using a different substance as a reference standard. By determining the absorbance of both substances, and by being aware of the ratio of their extinction coefficients, the amount of analyte can be calculated based on the absorbance values, the known extinction ratio, and the known amount of reference standard that was used. This allows the use of attractive reference standards for the analysis of complex mixtures such as a drug substance comprising multiple long peptides. Small molecule reference standards could be used, for instance even commercially available reference standards. For instance, Unites States Pharmacopeia (USP) reference standards are certified by that agency and come with a certificate of their content and stability. The use of more reliable reference standards allows the more precise quantification of analytes.

### Method

In a first aspect, the invention provides a method for producing a mixture comprising a known quantity of a first analyte, the method comprising the steps of:
i) providing a mixture comprising the first analyte;
ii) providing a reference standard comprising a known amount of a reference substance, wherein the reference substance is not the first analyte, wherein the reference substance is a small molecule, and wherein the ratio between the molar extinction coefficient of the first analyte and the molar extinction coefficient of the reference substance is known;
iii) determining the absorbance of the first analyte and of the reference substance using spectrophotometry to obtain values for first analyte absorbance and for reference substance absorbance; and
iv) determining the content of the first analyte in the mixture based on the obtained absorbance values and the known ratio of molar extinction coefficients. Such a method is referred to herein as a method according to the invention.

### i) Provision of a Mixture

In step i) a mixture comprising the first analyte is provided. A mixture may be homogeneous or heterogeneous, although homogeneous mixtures are preferred for later spectroscopic analysis. A mixture may be colored or colorless. Examples of suitable mixtures include solutions, suspensions, emulsions, and colloids. A solution is preferred and is a homogeneous mixture which typically comprises a substance (solute) dissolved in another substance (solvent). Multiple further solutes may be present, for instance a second analyte or a third analyte, etc. Buffer salts may also be present, or additional solvents, or any other substances that are commonly found in analysis samples or in pharmaceutically acceptable compositions. The concentration of a given solute is the same throughout a solution. A solution may be clear, alternatively referred to herein as transparent or UV (ultraviolet radiation)-transparent. A skilled person understands that UV-transparency pertains to the solution in general, and that the absorption by the first analyte or by the reference standard is not to be considered as rendering a solution intransparent. In general a solution is UV-transparent if at least 10% of UV-light is transmitted through the solution, preferably at least 50%, more preferably at least 90%. Preferably the UV-transparency of 1 cm of the mixture is at least within 10% of the transparency of 1 cm of water. Accordingly, in some embodiments, the mixture provided in step i) is a solution, preferably it is a UV-transparent solution. The skilled person understands that the term mixture further encompasses samples of mixtures. A “sample” refers to a representative portion of a larger mixture being separated and analyzed using the methods of the invention. A sample may be a diluted sample, i.e. a sample wherein the concentration of its components have been decreased by a known factor (dilution factor or DF). A mixture may also be a reconstituted mixture, wherein the analytes to be measured are provided as dried material. Dry analytes are preferably lyophilized analytes. When a dry mixture is provided, it can be the case that the mixture consists of only the first analyte. After reconstitution, an actual mixture as described above will be obtained. A skilled person knows how to reconstitute analytes. For instance, for peptides, reconstitution is described in W02017/220463.

The term “analyte” as used herein encompasses any type of molecule provided that it can be analyzed by the methods described later herein. Examples of suitable analytes include polypeptides, proteins, glycoproteins, lipoproteins, nucleic acids, polynucleotides, oligonucleotides, DNA, RNA, polypeptide analogues, polynucleotide analogues, sugars, complex carbohydrates, complex lipids, polymers, small organic molecules such as drugs and drug-like molecules, and mixtures thereof. A preferred analyte is a peptide. A peptide to be analysed can be synthetic or can be derived from a larger protein via digestion. Preferably the peptide is synthetic. The terms “peptide” or “protein” or “amino acid sequence” can be used interchangeably herein as will be clear from context. A residue in a peptide may be any proteinogenic amino acid, but also any non-proteinogenic amino acid such as D-amino acids and modified amino acids formed by post-translational modifications, and also any non-natural amino acid.

Preferred peptide is derived from a protein antigen. The term “protein antigen” as used herein refers to a protein that comprises antigenic regions capable of inducing an immune response in a subject. A peptide is “derived” from a protein antigen when it comprises a contiguous amino acid sequence selected from the protein antigen, which may optionally be further modified by deletion, insertion or substitution of one or more amino acids, or by extension or shortening at the N- and/or C-terminus with additional amino acids or functional groups, using standard molecular toolbox methods known in the art, also described in standard handbooks like Ausubel et al., Current Protocols in Molecular Biology, 3rd edition, John Wiley & Sons Inc (2003) and in Sambrook and Green, Molecular Cloning. A Laboratory Manual, 4th Edition, Cold Spring Harbor Laboratory Press (2012). Peptide modifications may result in improved stability, bio-availability, or targeting to T-cells.

Protein antigens that are specifically expressed by infected, pre-cancerous and/or cancerous cells are particularly preferred. Such protein antigens may be viral or non-viral antigens. Examples of viral antigens are antigens derived from Epstein Bar virus induced lymphoma's (EBV), Human T lymphotrophic virus I, Hepatitis B virus (HBV), Human papilloma virus (HPV), Kaposi sarcoma herpes virus (KSHV), Hepatitis C virus (HVC), KSV, Merkel cell carcinoma virus, SARS-associated coronavirus (such as SARS-CoV-2), and the like. Examples of viral protein antigens are protein antigens from EBV, e.g. LMP1 or late membrane protein 1 (e.g. UniprotKB P03230) and LMP2 or late membrane protein 2 (e.g. UniprotKB PI3285); protein antigens from Human T lymphotrophic virus I, e.g. Tax protein (e.g. UniprotKB P14079; P0C213; P03409); protein antigens from HBV e.g. genotypes A, B, C or D, e.g. protein hBsAg (e.g. UniprotKB Q773S4), X-protein (e.g. UniprotKB Q8V1H6) large envelope protein (e.g. UniprotKB P03138) and capsid protein (e.g. UniprotKB P03147); protein antigens from HCV, e.g. genome polyprotein (e.g. UniprotKB P26663; Q99IB8; A3EZI9) and HCV protein (e.g. UniprotKB Q99398); protein antigens from HPV e.g. oncogenic genotypes 6, 11, 16, 18, 31, 33, 45, 52, 58, 59, 68 e.g. E6 oncoprotein (e.g. UniprotKB P03126; P06463) and E7 oncoprotein (e.g. UniprotKB P03129; P06788) protein antigens from KSHV, e.g. protein ORF36 (e.g. UniprotKB F5HGH5), Core gene UL42 family protein (e.g. UniprotKB Q77ZG5), virion egress protein UL31 homo log (e.g. UniprotKB F5H982), Triplex capsid protein VP19C homolog (e.g. UniprotKB F5H8Y5), viral macrophage inflammatory protein 2 (e.g. UniprotKB 098157), mRNA export factor ICP27 homolog (e.g. UniprotKB Q2HR75), ORF52 (e.g. UniprotKB F5HBL8), Viral IRF4-like protein (e.g. UniprotKB Q2HR73), Bcl-2 (e.g. UniprotKB 076RI8), Large tegument protein deneddylase (e.g. UniprotKB Q2HR64), V-cyclin(e.g. UniprotKB 040946), VIRF-(e.g. UniprotKB F5HF68) and E3 ubiquitin-protein ligase MIR1 (e.g. UniprotKB P90495); antigen protein Merkel cell carcinoma virus, e.g. large T protein (e.g. UniprotKB E2IPT4; K4P159), e.g. small T protein (e.g. UniprotKB B6DVX0; B6DVX6).

Non-viral antigens may be tumor specific antigens and/or tumor associated antigens. Tumor specific antigens are antigens that are exclusively expressed by tumor cells and not by any other cell and are often mutated proteins, such as KrasG21° and mutant P53, or neo-antigens developed in due course by DNA mutations and malfunctioning DNA repair mechanisms. Tumor associated antigens are endogenous antigens present in both tumor and normal cells but are dysregulated in their expression or cellular localization, such as the HER-2/neu receptor. Non limiting examples of non-viral antigens are Her-2/neu (or ErbB-2, Human Epidermal growth factor Receptor 2 (e.g. UniprotKB P04626); WT-1 or Wilms tumor protein (e.g. UniprotKB P19544); NY-ESO-1 or cancer/testis antigen 1 (e.g. UniprotKB P78358); MAGE-A3 or melanoma-associated antigen-A3 (e.g. UniprotKB P43357); BAGE or B melanoma antigen (e.g UniProtKB Q13072); CEA or carcinoembryonic antigen (e.g UniProtKB Q13984); AFP or a-fetoprotein (e.g UniProtKB P02771); XAGE-IB or X antigen family member 1 (e.g UniProtKB Q9HD64); survivin or BIRC5, Baculoviral IAP repeat-containing protein 5 (e.g. UniprotKB 015392); P53 (e.g. UniprotKB P04637); h-TERT or Telomerase reverse transcriptase (e.g. UniprotKB 014746); mesothelin (e.g. UniProtKB H3BR90); PRAME or Melanoma antigen preferentially expressed in tumors (e.g. UniprotKB P78395); MUC-1 or mucin-1 (e.g. UniprotKB P15941); Mart-1/Melan-A or Melanoma antigen recognized by T-cells 1 (e.g. UniprotKB Q16655); GP-100 or Melanocyte protein PMEL (e.g. UniprotKB P40967); tyrosinase (e.g. UniprotKB U3M8N0); tyrosinase-related protein-1 (e.g. UniprotKB P17643); tyrosinase-related protein-2 (e.g. UniprotKB 075767); PAP or PAPOLA, Poly(A) polymerase alpha (e.g. UniprotKB P51003); PSA or Prostate-specific antigen (e.g. UniprotKB P07288); PSMA or prostate-specific membrane antigen, or Glutamate carboxypeptidase 2 (e.g. UniprotKB Q04609).

A peptide may comprise or consist of a non-naturally occurring sequence as a result of comprising additional amino acids not originating from the protein antigen the peptide is derived from and/or as a result of comprising a modified amino acid and/or a non-naturally occurring amino acid and/or a covalently linked functional group such as a fluorinated group, a fluorocarbon group, a human toll-like receptor ligand and/or agonist, an oligonucleotide conjugate, PSA, a sugar chains or glycan, a pam3cys and/or derivative thereof, preferably such as described in WO2013051936A1, CpG oligodeoxynucleotides (CpG-ODNs), cyclic dinucleotides (CDNs), a DC pulse cassette, a tetanus toxin derived peptide, a human HMGB1 derived peptide; either within the peptide or appended to the peptide, as described above. A peptide may comprise 2-aminoisobutyric acid (Abu, an isostere of cysteine). A cysteine of a peptide may be replaced by Abu. A peptide is preferably an isolated peptide, i.e. is a peptide that has been subjected to human manipulation and has been removed from its natural surroundings.

A peptide is preferably an antigenic peptide. The term “antigenic peptide” as used herein refers to a peptide which is immunogenic and capable of inducing a combined antigen-directed CD4+T helper and CD8+cytotoxic T cell response, when administered, such as in a pharmaceutical composition like a vaccine, to a subject, for example an animal or a human subject. The assessment of immunogenicity may be done using in vivo, in vitro or ex vivo techniques that are standard in the art, such as radioimmune precipitation, ELISA, electrochemiluminescence, and the like.

In some embodiments, the first analyte is a peptide, preferably having a length from 5 to 100 amino acids. Preferably, the peptide has a length from 5 to 100 amino acids, from 5 to 95 amino acids, from 5 to 90 amino acids, from 5 to 85 amino acids, from 5 to 80 amino acids, from 5 to 75 amino acids, from 5 to 70 amino acids, from 5 to 65 amino acids, from 5 to 60 amino acids, from 5 to 55 amino acids, from 10 to 50 amino acids, from 10 to 40 amino acids, from 15 to 40 amino acids, from 17 to 39 amino acids, from 19 to 43 amino acids, from 22 to 40 amino acids, from 22 to 45 amino acids, from 28 to 40 amino acids, or from 30 to 39 amino acids, more preferably from 10 to 50 amino acids. Preferably, the peptide has a length of at most 100, 99, 98, 97, 96, 95, 94, 93, 92, 91, 90, 89, 88, 87, 86, 85, 84, 83, 20 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, or 30, 29, 28, 27, 26, 25, 24, 23, 22, 21, 20, 19, 18, 17, 16, 15, 14, 13, 12, 11, or 10 amino acids. Preferably, the peptide has a length of at least 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 amino acids.

A peptide may be derived from human papilloma virus (HPV), for example from the early HPV antigen proteins E2, E6, or E7. Preferably, the HPV protein is selected from E6 or E7 and is derived from a high risk HPV serotype, such as serotype 6, 11, 16, 18, 31, 33, 45, 52, 58, 59, 68 preferably from serotype 16 or 18. Examples of HPV-derived peptides are described in W02017/220463 and PCT/EP2021/052738.

A peptide may be also derived from hepatitis B virus (HBV), for example from the surface, polymerase, core or X-protein antigen proteins. Preferably, the HBV protein is selected from highly conserved regions from prevalent HBV genotypes, such as genotypes A, B, C or D. Examples of HBV-derived peptides are described in WO 2015/187009 and W02021/110919.

Furthermore, a peptide may be derived from a Severe Acute Respiratory Syndrome Corona Virus (SARS-CoV), for example from the structural proteins. Preferably the SARS-CoV protein is selected from immunogenic regions, harboring multiple T cell epitopes, within the Spike protein, the envelope protein, the membrane protein or the nucleocapsid protein. Examples of SARS-CoV-derived peptides are described in PCT/EP2021/060688.

Alternatively, a peptide may be derived from a cancer testis antigen like PRAME or Melanoma antigen preferentially expressed in tumors. Preferably the peptides are designed to comprise immunogenic regions of the PRAME protein. Examples of PRAME-derived peptides are described in W02008/118017 and W02017/220463.

In some embodiments, the first analyte is a peptide comprising a sequence represented by any one of SEQ ID NOs: 1-12, or by a sequence having at least 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% identity or similarity with any one of SEQ ID NOs: 1-12. More preferably the analyte has at least 90%, even more preferably at least 98% sequence identity with any one of SEQ ID NOs: 1-12, most preferably 100%.

The term “solvent” as used herein includes any solvent or mixture of solvents in which an analyte as described herein can be dissolved at a suitable concentration. The skilled person understands that the choice of a particular solvent will depend on the analyte. In the case of peptides, the number and types of ionic charges in the peptide typically determine its solubility in aqueous solutions. Generally, the more charged residues a peptide possesses the more soluble it is in aqueous solutions. Among the many exceptions to this general rule are peptide sequences that are very hydrophobic and those that tend to aggregate. While the hydrophobicity of the sequence is the primary cause of aggregation, peptides can also aggregate or “gel” through extensive hydrogen bonding network. The properties of different solvent categories may be found in standard handbooks such as Yizhak Marcus, The Properties of Solvents, John Wiley & Sons Inc. (1998) and Peter Atkins, Physical Chemistry, 11th edition, Oxford University Press (2018). Examples of suitable solvents include nonpolar (such as hydrocarbons like pentene, hexane, benzene, toluene; ethers like 1,4-dioxane, diethyl ether, tetrahydrofuran; chlorocarbons like chloroform), polar aprotic (such as dichloromethane, ethyl acetate, acetone, dimethylformamide, acetonitrile (MeCN), dimethyl sulfoxide (DMSO), nitromethane, propylene carbonate), and polar protic solvents (such as water, ammonia, formic acid, n-butanol, isopropyl alcohol, n-propanol, ethanol, methanol, acetic acid, trifluoroacetic acid). Solvents are preferably suitable for use during liquid chromatography such as HPLC. Preferably, a solvent is selected from water, isopropyl alcohol, and acetonitrile. A mixture according to the invention may optionally comprise a combination of different solvents. Optionally, a mixture will further comprise an acid or organic acid, such as acetic acid, formic acid, or trifluoroacetic acid (TFA), preferably formic acid or TFA.

In some embodiments, the mixture provided in step i) comprises the first analyte, preferably a peptide, and solvents, wherein the solvents are preferably selected from water, isopropyl alcohol, and acetonitrile, and wherein optionally an acid is present such as formic acid or trifluoroacetic acid.

A mixture comprising the first analyte may comprise one or more analytes in addition. Preferably, the one or more analytes in addition is a peptide as described earlier herein. In some embodiments, the mixture further comprises a second analyte, and optionally a third, fourth, fifth, sixth, seventh, eighth, ninth, tenth, eleventh, twelfth, thirteenth, fourteenth, or fifteenth analyte. In some embodiments, the mixture comprises 2 analytes, preferably peptides. In some embodiments, the mixture comprises 3 analytes, preferably peptides. In some embodiments, the mixture comprises 4 analytes, preferably peptides. In some embodiments, the mixture comprises 5 analytes, preferably peptides. In some embodiments, the mixture comprises 6 analytes, preferably peptides. In some embodiments, the mixture comprises 7 analytes, preferably peptides. In some embodiments, the mixture comprises 8 analytes, preferably peptides. In some embodiments, the mixture comprises 9 analytes, preferably peptides. In some embodiments, the mixture comprises 10 analytes, preferably peptides. In some embodiments, the mixture comprises 11 analytes, preferably peptides. In some embodiments, the mixture comprises 12 analytes, preferably peptides. In some embodiments, the mixture comprises 13 analytes, preferably peptides. In some embodiments, the mixture comprises 14 analytes, preferably peptides. In some embodiments, the mixture comprises 15 analytes, preferably peptides.

Preferred mixtures comprise peptides as described above, wherein a mixture preferably comprises SEQ ID NOs: 1-5 (referred to as DP-5P), or SEQ ID NOs: 6-12 (referred to as DP-7P).

### ii) Provision of a Reference Standard

In step ii) a reference standard comprising a known amount of a reference substance is provided, wherein the reference substance is not the first analyte, and wherein the ratio between the molar extinction coefficient of the first analyte and the molar extinction coefficient of the reference substance is known. The reference substance is preferably a small molecule. The reference standard may be provided separately or may be combined with the mixture comprising the first analyte provided in step i).

The term “reference standard” as used herein, alternatively referred to herein as a “drug reference standard”, has its customary meaning. It generally refers to a highly characterized material suitable to test the identity, quality, quantity, and/or purity of substances for e.g. pharmaceutical use. A reference standard may be prepared from a known amount of a reference substance using standard laboratory techniques for preparing mixtures, or alternatively may be bought from a commercial supplier. In both cases, the quantity (amount) of a reference substance in the reference standard is known, allowing later determination of the analyte content in the mixture in step iv), as described later herein. A reference standard may be a mixture of substances as described earlier herein. A reference standard may be a UV-transparent solution, as described earlier herein. The skilled person understands that the term also encompasses samples and diluted samples of reference standards. Preferably a reference standard is a solution of a known amount of a single reference substance in a solvent or mixture of solvents, wherein the reference substance is present at a known concentration. Alternately, when a reference standard is a solid, it can be dissolved in a known amount of solvent, wherein the solvent is preferably as described for the analyte mixture.

A small molecule preferably has a molecular weight of at most 1000 daltons, more preferably of at most 900 daltons, and even more preferably of at most 500 daltons. A small molecule is preferably an organic small molecule.

Preferably, a reference standard is a United States Pharmacopeia (USP) and/or a European Pharmacopeia (EDQM) reference standard, more preferably a United States Pharmacopeia (USP) reference standard; said standards conveniently being commercially available. Examples of suitable reference standards are standards comprising, essentially consisting of, or consisting of, preferably comprising, as a reference substance caffeine (USP Catalog Number 1085003), acetaminophen (USP Catalog Number 1003009), sulfadimethoxine (USP Catalog Number 1626001), verapamil (USP Catalog Number 1711202), reserpine (USP Catalog Number 1601000), amitriptyline (USP Catalog number 1029002), naphthalene (USP Catalog Number 1457083), butylparaben (USP Catalog Number 1084000), uracil (USP Catalog Number 1705753), and salts thereof. A preferred reference standard is a standard comprising, essentially consisting of, or consisting of, preferably consisting of, a solution of reserpine or a salt thereof.

In some embodiments, the reference standard is a standard comprising caffeine, acetaminophen, sulfadimethoxine, verapamil, reserpine, amitriptyline, naphthalene, butylparaben, uracil, sulfaguanidine, Val-Tyr-Val, leucine-enkephalin, terfenadine, or a salt thereof, preferably comprising caffeine, acetaminophen, sulfadimethoxine, verapamil, reserpine, amitriptyline, naphthalene, butylparaben, uracil, or a salt thereof, more preferably comprising reserpine or a salt thereof. Examples of such reference standards include commercially available mixtures such as the QDa QC Reference Material (Waters Corporation, MA, USA, Catalog number 186007345) and the Reversed-Phase QC Reference Material (Water Corporation, MA, USA, Catalog number 186007345).

The term “molar extinction coefficient” or “molar attenuation coefficient” or “molar absorptivity” as used herein has its customary meaning. It refers to the strength of light attenuation of a substance at a given wavelength, said property being an intrinsic property of the substance. The molar extinction coefficient may be expressed in square meters per mole (m2/mol), or alternatively in liters per mole per centimeter (L·mol⁻¹·cm⁻¹). The molar extinction coefficient of a given substance may be determined using the Beer-Lambert law, represented by Formula I below:

A_{λ}=ε⋅c⋅L (Formula I),

wherein
A_{λ} represents the (light) absorbance of the substance at a certain light wavelength, said absorbance being decadic (10-based) or Napierian (e-based),
ε represents the molar extinction coefficient of the substance expressed in m^{2/}mol or L mol⁻¹ cm⁻¹,
c represents the molar concentration of the substance expressed in mol/L, and
L represents the light path length expressed in cm.

Solving this expression for concentration, one can see what values are needed to determine the concentration of a peptide or protein solution c=A/ε L (=A/ε when L=1 cm). Dividing the measured absorbance of an analyte such as a peptide or protein solution by a calculated or known molar extinction coefficient yields the molar concentration of the analyte solution.

The ratio of radiant power transmitted (P) by a sample to the radiant power incident (Po) on the sample is called the transmittance, T, which follows the formula T=P/Po. Absorbance (A), then, is defined as the logarithm (base 10) of the reciprocal of the transmittance according to the formula A=−log T=log (1/T). In a spectrophotometer, monochromatic plane-parallel light enters a sample at right angles to the plane-surface of the sample. In these conditions, the transmittance and absorbance of a sample depends on the molar concentration (c), light path length in centimeters (L), and molar absorptivity (ε) for the dissolved substance at the specified wavelength (λ). Related formulae are T_{λ}=10^{εcL} and A_{λ}=ε c L (Formula I).

The Beer-Lambert Law states that molar absorptivity is constant (and the absorbance is proportional to concentration) for a given substance dissolved in a given solute and measured at a given wavelength. For this reason, molar absorptivities may be called molar absorption coefficients or molar extinction coefficients. Because transmittance and absorbance have no unit, the units for molar absorptivity must cancel with units of measure in concentration and light path. Therefore, molar absorptivities have units of M⁻¹ cm⁻¹(L·mol⁻¹·cm⁻¹). Standard laboratory spectrophotometers are fitted for use with 1 cm-width sample cuvettes; hence, the path length is generally assumed to be equal to one and the term is dropped altogether in most calculations, as per this formulae: A_{λ}=ε c L=ε c when L=1 cm. When a spectrophotometer is in-line in a chromatographic device such as an HPLC, the machine generally calculates for its own path length in its measurement unit.

A skilled person is aware that there is no single correct extinction coefficient value for a complex molecule such as a peptide. Differences in buffer type, ionic strength, and pH can affect absorptivity values. Therefore, the best extinction coefficient value is one that is determined empirically.

The molar extinction coefficient of a reference substance and/or analyte may be determined at a wavelength that is suitable for said substance and/or analyte. In some embodiments, the molar extinction coefficient of a reference substance and/or analyte is the molar extinction coefficient determined at a wavelength from 180 to 800 nm, preferably from 200 to 600 nm, more preferably from 200 to 400 nm such as at 200 nm, 254 nm, or 280 nm. In some embodiments, the molar extinction coefficient of a reference substance and/or analyte is the molar extinction coefficient determined at a wavelength of at least 180 nm, at least 190 nm, at least 200 nm, at least 210 nm, at least 220 nm, at least 230 nm, at least 240 nm, at least 250 nm, at least 260 nm, at least 270 nm, at least 280 nm, at least 290 nm. at least 300 nm, at least 310 nm, at least 320 nm, at least 330 nm, at least 340 nm, at least 350 nm, at least 360 nm, at least 370 nm, at least 380 nm, at least 390 nm, at least 400 nm, at least 410 nm, at least 420 nm, at least 430 nm, at least 440 nm, at least 450 nm, at least 460 nm, at least 470 nm, at least 480 nm, at least 490 nm, at least 500 nm, at least 510 nm, at least 520 nm, at least 530 nm, at least 540 nm, at least 550 nm, at least 560 nm, at least 570 nm, at least 580 nm, at least 590 nm, at least 600 nm, at least 610 nm, at least 620 nm, at least 630 nm, at least 640 nm, at least 650 nm, at least 660 nm, at least 670 nm, at least 680 nm, at least 690 nm, at least 700 nm, at least 710 nm, at least 720 nm, at least 730 nm, at least 740 nm, at least 750 nm, at least 760 nm, at least 770 nm, at least 780 nm, at least 790 nm, or at least 800 nm. A preferred wavelength is about 220 nm. Another preferred wavelength is 254 nm or about 254 nm. Another preferred wavelength is 280 nm or about 280 nm. Another preferred wavelength is 510 nm or about 510 nm.

The molar extinction coefficient of the first analyte and the molar extinction coefficient of the reference substance comprised in the reference standard are known. Said values may be obtained for a given analyte and/or reference substance from standard handbooks available in the art, such as the CRC handbook of chemistry and physics. Alternatively, the molar extinction coefficient at a given wavelength may be determined, as part of or prior to the method of the invention, using Formula I by measuring the absorbance of said analyte and/or substance at different molar concentrations. Because the molar extinction coefficients of the first analyte and the reference substance are known, their ratio may be determined. Such a ratio is a dimensionless number.

Alternatively, the ratio between the molar extinction coefficient of the first analyte and the molar extinction coefficient of the reference substance comprised in the reference standard may be represented by the “relative response factor” (RRF) between the analyte and the reference substance. Said factor directly depends on the ratio of said molar extinction coefficients and is a dimensionless number that can be calculated as follows:

$$R R F = \frac{R {F}_{analyte}}{R {F}_{ref substance}} , \qquad Formula II ,$$

wherein
RRF represents the relative response factor;
RF_{analyte} represents the response factor of the analyte, which is the area under the curve as determined for the analyte using a spectrophotometer that is in-line in a chromatographic device such as an HPLC;
RF_{ref substance} represents the response factor of the reference substance which is the area under the curve as determined for the reference substance using a spectrophotometer that is in-line in a chromatographic device such as an HPLC

The response factor (RF) of an analyte or a reference substance may be determined by measuring the absorbance of a mixture (at a certain light wavelength, for example 220 nm) wherein the analyte or reference substance is comprised at a known concentration value (e.g. at a known mg/mL value). The response factor can then be calculated by dividing the measured absorbance of said analyte or reference substance by the known concentration in the measured mixture. Said values may be a result of a single measurement or the average of multiple measurements to further increase precision. The response factor of an analyte or reference substance may be determined in mixture comprising only a single analyte or reference substance, or in mixtures wherein additional analytes or reference substances are present. An example of determination of the relative response factor is further provided in the experimental section herein. Determination of the relative response factor may be performed once per analyte and reference substance pair, after which the determined value may be used for further calculations.

In some embodiments, the reference substance has a molar extinction coefficient of from 0.1·10⁴ to 3·10⁴ L·mol⁻¹·cm⁻¹, preferably from 0.5·10⁴ to 2.0·10⁴L·mol⁻¹·cm⁻¹, more preferably from 0.9·10⁴ to 1.5·10⁴ L·mol⁻1·cm⁻¹. In some embodiments, the reference substance has a molar extinction coefficient of at least 0.1·10⁴, at least 0.2·10⁴, at least 0.3·10⁴, at least 0.4·10⁴, at least 0.5·10⁴, at least 0.6·10⁴, at least 0.7 ·10⁴, at least 0.8·10⁴, at least 0.9·10⁴, at least 0.95·10⁴, at least 1·10⁴, at least 1.1·10⁴, at least 1.2·10⁴, at least 1.3·10⁴, at least 1.4·10⁴, at least 1.5·10⁴, at least 1.6·10⁴, at least 1.7·10⁴, at least 1.8·10⁴, at least 1.9—10⁴, at least 2.0·10⁴, at least 2.1·10⁴, at least 2.2·10⁴, at least 2.3·10⁴, at least 2.410⁴, at least 2.5·10⁴, at least 2.6·10⁴, at least 2.7·10⁴, at least 2.8·10⁴, at least 2.9·10⁴, or at least 3.0·10⁴ L mol⁻¹·cm⁻¹. A preferred molar extinction coefficient value is at least 0.975·10⁴ L·mol⁻¹ ·cm^{31 1} or about 0.975·10⁴ L mol⁻¹·cm⁻¹.

In embodiments wherein the mixture comprising the first analyte further comprises a second analyte, and optionally a third, fourth, fifth, sixth, seventh, eighth, ninth, tenth, eleventh, twelfth, thirteenth, fourteenth, or fifteenth analyte as described earlier herein, it is preferable that the ratios between the molar extinction coefficients of each analyte and the molar extinction coefficient of the reference substance are known. Said ratios may be determined by knowing the molar extinction coefficient of each analyte and the reference substance, which may be obtained as described earlier herein. The ratios may also be represented by the relative response factors between each analyte and the reference substance, as described earlier herein. Preferably, said analytes are peptides as described earlier herein.

It is preferred that both the composition comprising the analyte and the composition that is the reference standard are similar, having the same solvents or buffer components. In other words these compositions preferably differ only in the dissolved reference substance and the dissolved analyte. Herein, the dissolved analyte may of course also refer to possible impurities, if any.

### Step iii) Determining Absorbance

In step iii) the absorbance of the first analyte and of the reference substance is determined using spectrophotometry, preferably ultraviolet-visible spectroscopy, to obtain values for first analyte absorbance and for reference substance absorbance. In embodiments wherein the mixture comprising the first analyte further comprises a second analyte, and optionally a third, fourth, fifth, sixth, seventh, eighth, ninth, tenth, eleventh, twelfth, thirteenth, fourteenth, or fifteenth analyte as described earlier herein, or even additional analytes, their absorbance may also be determined in the same way. Determination of absorbance of the first analyte in the mixture and of the reference substance comprised in the reference standard may be optionally done for equal volumes of said mixture and reference standard. However, the method is not limited to equal volumes and any ratio of volumes may be contemplated, as long as said ratio is known.

The term “ultraviolet-visible spectroscopy” or “ultraviolet-visible spectrophotometry” as used herein has its customary meaning. It refers to absorption spectroscopy in the ultraviolet and the full, adjacent visible regions of the electromagnetic spectrum. It can also refer to reflectance spectroscopy, where the invention can be practiced using reflecting ratios instead of absorption ratios—although absorption is preferred. Determination of absorbance is preferably done at a wavelength for which the molar extinction coefficient of the analyte and of the reference substance is known, as described earlier herein. Determination of absorbance may be performed using routine laboratory techniques, such as the use of a spectrophotometer. Alternatively, determination of absorbance may be performed using analytical liquid chromatography, in a device equipped with an in-line spectrophotometer. Determination of absorbance of an analyte in the mixture and of the reference substance comprised in the reference standard using analytical liquid chromatography may be done separately, or alternatively a known amount of reference substance may be added to the mixture. In the latter case, the first (and one or more further analytes as described above) analyte and the reference substance may be separated and their absorbance values may be determined individually.

Liquid chromatography is well known and includes chromatographic methods in which compounds are partitioned between a liquid mobile phase and a solid stationary phase. Liquid chromatographic methods are used for analysis, quantification, or purification of compounds. The liquid mobile phase can have a constant composition throughout the procedure (an isocratic method), or the composition of the mobile phase can be changed during elution (e.g., a gradual change in mobile phase composition such as a gradient elution method). The term “mobile phase” describes a solvent system (such as a liquid) used to carry a compound of interest into contact with a solid phase (e.g., a solid phase in a solid phase extraction (SPE) cartridge or HPLC column) and to elute a compound of interest from the solid phase. The term “separation” describes a process in which a mixture carried by a liquid is separated into components as a result of differential distribution of the solutes as they flow around or over a stationary liquid or solid phase. Examples of suitable liquid chromatographic methods include HPLC, reverse phase-HPLC, reversed phase rapid-HPLC (UPLC), ultra-performance liquid chromatography, fast-performance liquid chromatography, HILIC, size-exclusion chromatography (SEC), gel permeation chromatography (GPC), and the like. Protocols and methods for liquid chromatography are well-known in the art, and also described in standard handbooks such as Meyer, Practical High-Performance Liquid Chromatography, 5th edition, John Wiley & Sons Inc. (2010), Kastner, Protein Liquid Chromatography, volume 61, 1St edition, Elsevier Science (1999), and Liquid Chromatography Applications, eds Fanali, Haddad et al., Elsevier Science (2013). Further examples of suitable chromatographic methods are provided in the experimental section herein. Preferred liquid chromatographic methods are HPLC and UPLC. Chromatography is very attractive for methods according to the invention because it allows the convenient spectrophotometric analysis of multiple analytes in a single mixture.

Accordingly, in some embodiments, step iii) is performed using analytical liquid chromatography, such as HPLC or UPLC, and optionally comprises the following sub-steps:
iii-a) adding a known amount of reference substance to the mixture;
iii-b) separating the first analyte and the reference substance using liquid chromatography;
iii-c) determining the absorbance of the first analyte and of the reference substance using spectrophotometry, preferably ultraviolet-visible spectroscopy, to obtain values for first analyte absorbance and for reference substance absorbance.

In some embodiments, step iii) is performed using analytical liquid chromatography, such as HPLC or UPLC, and optionally comprises the following sub-steps:
iii-a) adding a known amount of reference substance to the mixture;
iii-b) separating the first analyte, the one or more additional analytes such as the second analyte and optionally the third, fourth, fifth, sixth, seventh, eighth, ninth, tenth, eleventh, twelfth, thirteenth, fourteenth, or fifteenth analyte, and the reference substance using liquid chromatography;
iii-c) determining the absorbance of the first analyte and of the reference substance using spectrophotometry, preferably ultraviolet-visible spectroscopy, to obtain values for first analyte absorbance and for reference substance absorbance.

Preferably absorbance is determined in all instances using the same conditions.

### Step iv) Determining the Content of the Analyte

A result of step iii) is that absorption values are obtained for the analyte and for the reference substance. In step iv) the content of the first analyte in the mixture is determined based on these obtained absorbance values and the known ratio of molar extinction coefficients. The known ratio between the molar extinction coefficients may be represented by the relative response factor (RRF) between the first analyte and the reference substance, as described earlier herein. Calculating the content of the first analyte in the mixture is then possible because the quantity (amount) of the reference substance is known as described earlier herein. Accordingly, only a single variable (the quantity of analyte) in the relationship between the analyte and the reference substance remains unknown, and this equation can be solved (for quantity of the analyte) based on the known information.

In embodiments wherein the mixture comprising the first analyte further comprises a second analyte, and optionally a third, fourth, fifth, sixth, seventh, eighth, ninth, tenth, eleventh, twelfth, thirteenth, fourteenth, or fifteenth analyte as described earlier herein, their content may also be determined in the same way. The skilled person understands that any of steps i)-iv) as described above may be repeated multiple times for each of the analytes and/or reference standard. Obtained values may then be averaged and statistical analysis may be performed according to standard methods in the art, such as calculation of the standard deviation.

The term “impurity” as used herein has its customary meaning. It refers to any component of a mixture, such as the mixtures and reference standards described above, that is not the material defined as comprised in said mixture. The presence of impurities may be quantified using the purity value, which may be expressed as the dimensionless ratio of actual amount of desired material 100 divided by the total amount of material comprised in a mixture. A completely pure material will have a purity of unity (1). The purity value of a material in a mixture may be known, for example when said mixture is purchased from a commercial supplier such as in the case of USP reference substances and standards. Alternatively, the purity value may be determined using the methods of the invention, when the molar extinction coefficient of an impurity comprised in said mixture is known or determined as described above. In this case, the impurity is treated as an analyte comprised in the mixture. Alternatively, the purity value may be determined using the methods of the invention after the content of the material defined as comprised in said mixture has been quantified, by subtracting said content from the overall material content in said mixture.

An exemplary determination of the content of an analyte in the mixture in step iv) of the methods of the invention, in an embodiment wherein may be performed using Formula III below:

$$Analyte content = \frac{{A}_{analyte} \cdot {Q}_{R S} \cdot {P}_{R S} \cdot D F}{{A}_{R S} \cdot R R F} \qquad ( Formula III )$$

wherein
Analyte content is expressed in mg,
A_{analyte} represents the absorbance of the analyte,
Q_{RS} represents the quantity of the reference substance expressed in mg,
P_{RS} represents the purity of the reference substance in the reference standard (expressed in a ratio of 1 or lower),
DF represents the dilution factor,
A_{RS} represents the absorbance of the reference substance, and
RRF (relative response factor) represents the ratio of the molar extinction coefficients between the analyte and the reference substance, as described earlier herein.

Alternately, the analyte content can be determined by the following derived formula:

$$Analyte content = \frac{{A}_{analyte} \times {Q}_{R S}}{{A}_{R S} \times R R F}$$

The skilled person understands that Formula III may be further adapted depending on mixture and/or reference standard preparation procedures and depending on whether equal volumes of the mixture and reference standard or a known ratio thereof were used. For example, when the mixture comprising the analyte is prepared using a vial containing lyophilized material, the analyte content may be determined as content of analyte per vial; such adaptations being well within its skillset. An exemplary such adaptation is further provided in the examples.

Accordingly, in some embodiments, the mixture further comprises a second analyte and optionally a third, fourth, fifth, sixth, seventh, eighth, ninth, tenth, eleventh, twelfth, thirteenth, fourteenth, or fifteenth analyte as described earlier herein, preferably the ratio between the molar extinction coefficients of each analyte and the molar extinction coefficient of the reference substance being known, and the absorbance of each analyte is determined in step iii), and the content of each analyte is determined in step iv).

The methods of the invention are useful in determining losses of analytes, preferably of peptides, during downstream processing that may be applied after their production. This can be achieved by determining the analyte content in a mixture as described herein after its production, followed by determination of the analyte content after downstream processing has been applied to the mixture. The losses in analyte content may then be calculated as the difference in the analyte content between the measurements. Downstream processing methods are known in the art and discussed in standard handbooks, such as Wesselingh, J. A and Krijgsman, J., 1st edition, Downstream Processing in Biotechnology, Delft Academic Press, (2013) and Protein Downstream Processing: Design, Development and Application of High and Low-Resolution Methods, Labrou N. (ed), Humana Press (2014). Examples include alteration of pH, solvent extraction, dialysis, filtration, ultrafiltration, concentration, lyophilisation and the like. Therefore in some embodiments the method according to the invention is performed to determine analyte concentration, after which downstream processing such as filtration is performed, after which the method according to the invention is performed an additional time.

The methods of the invention are associated with at least one or more of the following benefits as compared to conventional methods of quantification of analytes and/or impurities in complex mixtures, particularly of peptide-based drug substances and/or impurities in a peptide drug product: easier and more reproducible reference standard preparation, increased accuracy and/or precision in quantification of analytes, decreased measurement variation in quantification of analytes in mixtures coming from different production batches or from different time points of the same production batch.

### COMPOSITION

The invention provides a composition comprising an analyte as described earlier herein, wherein the analyte has been quantified to within precise margins whose establishment was hitherto not yet possible. The composition may be a mixture, as described earlier herein. In some embodiments, the composition is a pharmaceutical composition, optionally further comprising one or more pharmaceutically acceptable ingredients. In some embodiments, the composition is a vaccine. The one or more pharmaceutically acceptable ingredients may be for instance pharmaceutically acceptable carriers, fillers, stabilizers, preservatives, solubilizers, vehicles, and diluents. The skilled person understands that the specific ingredient will depend on the comprised analyte and the application of the composition. Suitable pharmaceutically acceptable excipients are known in the art and may for instance be found in Remington: The Science and Practice of Pharmacy, 23rd edition, Elsevier (2020).

In some embodiments, a composition further comprises one or more immune response stimulating compounds or adjuvants. Examples of suitable compounds include adjuvants that are known to act via the Toll-like receptors and/or via a RIG-1 (Retinoic acid- Inducible Gene-1) protein and/or via an endothelin receptor. Adjuvants that are capable of activation of the innate immune system can be activated particularly well via Toll like receptors (TLRs), including TLRs 1-10. Compounds capable of activating TLR receptors and modifications and derivatives thereof are well documented in the art. TLR1 may be activated by bacterial lipoproteins and acetylated forms thereof, TLR2 may in addition be activated by Gram positive bacterialglycolipids, LPS, LPA, LTA, fimbriae, outer membrane proteins, heat shock proteins from bacteria or from the host, and Mycobacterial lipoarabinomannans. TLR3 may be activated by dsRNA, in particular of viral origin, or by the chemical compound poly(LC). TLR4 may be activated by Gram negative LPS, LTA, Heat shock proteins from the host or from bacterial origin, viral coat or envelope proteins, taxol or derivatives thereof, hyaluronan containing oligosaccharides and fibronectins. TLRS may be activated with bacterial flagellae or flagellin. TLR6 may be activated by mycobacterial lipoproteins and group B Streptococcus heat labile soluble factor (GBS-F) or Staphylococcus modulins. TLR7 may be activated by imidazoquinolines, such as imiquimod, resiquimod and derivatives imiquimod or resiquimod (e.g. 3M-052). TLR9 may be activated by unmethylated CpG DNA or chromatin—IgG complexes. In particular TLR3, TLR7 and TLR9 play an important role in mediating an innate immune response against viral infections, and compounds capable of activating these receptors are particularly preferred. Particularly preferred adjuvants comprise, but are not limited to, synthetically produced compounds comprising dsRNA, poly(I:C), poly I:CLC, unmethylated CpG DNA which triggers TLR3 and TLR9 receptors, IC31, a TLR9 agonist, IMSAVAC, a TLR4 agonist, Montanide ISA-51, Montanide ISA 720 (an adjuvant produced by Seppic, France). RIG-1 protein is known to be activated by dsRNA just like TLR3 (Kato et al, (2005) Immunity, 1: 19-28). A particularly preferred TLR ligand is a pam3cys and/or derivative thereof, preferably a pam3cys lipopeptide or variant or derivative thereof, preferably such as described in WO2013051936A1, more preferably U-Paml2 or U-Paml4 or AMPLIVANT®. Further preferred adjuvants are Cyclic dinucleotides (CDNs), Muramyl dipeptide (MDP) and poly-ICLC. In preferred embodiments, the adjuvants are non-naturally occurring adjuvants such as the pam3cys lipopeptide derivative as described in WO2013051936A1, Poly-ICLC, imidazoquino line such as imiquimod, resiquimod or derivatives thereof, CpG oligodeoxynucleotides (CpG-ODNs) having a non-naturally occurring sequence, and peptide-based adjuvants, such as muramyl dipeptide (MDP) or tetanus toxoid peptide, comprising non-naturally occurring amino acids. Further preferred are adjuvants selected from the group consisting of 1018 ISS, aluminum salts, Amplivax, AS 15, BCG, CP-870,893, CpG7909, CyaA, dSLIM, GM-CSF, IC30, IC31, ImuFact EV1P321, IS Patch, ISS, ISCOMATRIX, Juvlmmune, LipoVac, MF59, monophosphoryl lipid A, Montanide IMS 1312, Montanide ISA 206, Montanide ISA 50V, OK-432, OM-174, OM-197-MP-EC, ONTAK, PepTel.RTM, vector system, PLGA microparticles, SRL172, Virosomes and other Virus-like particles, Pam3Cys-GDPKHPKSF, YF-17D, VEGF trap, R848, beta-glucan, Aquila's QS21 stimulon, vadimezan, AsA404 (DMXAA), STING (stimulator of IFN genes) agonist (e.g. c-di-GMP VacciGrade™), PCI, NKT (natural killer T cell) agonist (e.g. alphagalactosylceramide or alpha-GalCer, RNAdjuvant® (Curevac), retinoic acid inducible protein I ligands (e.g. 3pRNA or 5′-triphosphate RNA).

In preferred embodiments, the composition comprises a peptide, and preferably comprises a second, a third, fourth, fifth, sixth, seventh, eighth, ninth, tenth, eleventh, twelfth, thirteenth, fourteenth, or fifteenth peptide as described earlier herein. It is highly preferred that the composition comprises at least 5 peptides, such as comprising 5 or 7 peptides, preferably as described elsewhere herein.

In embodiments wherein multiple different peptides are comprised in a composition, it is advantageous that the content of each peptide, expressed in weight percentage, in said composition is as close to the average weight percentage of all different peptides as possible. In other words, that there is the same amount by weight of each peptide. Said compositions may be advantageously specified using the methods of the invention, which enable improved quantification of analytes such as peptides in complex mixtures. Particularly in pharmaceutical compositions such as vaccines, said property may increase their efficacy and decrease potential side effects. Determination of the weight content of each peptide in said compositions over time is further particularly important for assessment of their stability. It also assists in meeting compliance requirements.

Accordingly, in some embodiments, the composition comprises at least four, at least five, at least six, at least seven, at least eight, at least nine, at least ten, at least eleven, at least twelve, at least thirteen, at least fourteen, at least fifteen, preferably at least four different peptides, as defined earlier herein, wherein the weight percentage of each peptide is from 93% to 103% of the average weight percentage of all different peptides. Such a weight percentage is preferably at least over 93% of the average, preferably over 94%, more preferably over 95%, more preferably over 96%, more preferably over 97%, more preferably over 98%, most preferably over 99%. Such a weight percentage is preferably at most below 103% of the average, more preferably below 102%, most preferably below 101%.

The weight percentage of the different peptides may be determined at least after 1, 2, 3, 4, 5, 6, 7, 8, 9, 10, 11, 12, 18, 24, 30, 36, 42, 48, 54, or after 60 months, preferably after 48 months, 54 months, or 60 months after the production of the composition.

In some embodiments, the composition comprises at least four, at least five, at least six, at least seven, at least eight, at least nine, at least ten, at least eleven, at least twelve, at least thirteen, at least fourteen, at least fifteen, preferably at least four different peptides, as defined earlier herein, wherein the weight percentage of each peptide is from 95% to 103% of the average weight percentage of all different peptides, wherein said weight percentage is determined 48 months after production of the composition.

In some embodiments, the composition comprises at least four, at least five, at least six, at least seven, at least eight, at least nine, at least ten, at least eleven, at least twelve, at least thirteen, at least fourteen, at least fifteen, preferably at least four different peptides, as defined earlier herein, wherein the weight percentage of each peptide is from 95% to 101% of the average weight percentage of all different peptides, wherein said weight percentage is determined 54 months after production of the composition.

In some embodiments, the composition comprises at least four, at least five, at least six, at least seven, at least eight, at least nine, at least ten, at least eleven, at least twelve, at least thirteen, at least fourteen, at least fifteen, preferably at least four different peptides, as defined earlier herein, wherein the weight percentage of each peptide is from 93% to 100% of the average weight percentage of all different peptides, wherein said weight percentage is determined 60 months after production of the composition.

In preferred compositions as described herein, the total weight of analyte such as peptides in a composition is at most 10 mg or at most 5 mg, preferably at most 4 mg, more preferably at most 3 mg, most preferably at most about 2 mg, such as 2 mg. Due to the technical challenges associated with precisely weighing and analyzing peptides in such small quantities, the presently described methods allow the provision of mixtures of for instance five or seven peptides, wherein each peptide is present in a predetermined amount such as in an equal amount, and wherein the peptide amounts can be quantified and verified to indeed be of these desired amounts.

Minimization of variation in peptide content in compositions between different production batches is further desirable, in particular for pharmaceutical compositions such as vaccines. Accordingly, in some embodiments, a plurality of compositions comprising at least a first composition and a second composition, wherein the first and the second composition are each a composition as described earlier herein, wherein the composition differ from each other in that the compositions originate from different production batches, wherein the weight percentage of each peptide comprised in the first composition is from 93 to 103% of the weight percentage of that same peptide as comprised in the second composition, wherein preferably the compositions comprise one of:

DP-5P) five different peptides, each peptide comprising one of SEQ ID NOs: 1-5; or

DP-7P) seven different peptides, each peptide comprising one of SEQ ID NOs: 6-12.

For each reference to any one of SEQ ID NOs: 1-12, the peptides preferably have a length of at most 40 amino acids. More preferably the peptides consist of the sequence represented by the recited SEQ ID NOs. Preferably the weight percentage of each peptide comprised in the first composition is from 95 to 103% of the weight percentage of that same peptide as comprised in the second composition, more preferably from 95 to 101%. In some embodiments it is from 93 to 100%. The specifications are preferably stable, which can mean that the described values can be measured after at least 12 months, preferable 24, 36, more preferably 48, still more preferably 54, most preferably after 60 months.

In a further aspect, the invention provides a combination of a composition as described earlier herein and a reference standard as described earlier herein. In some embodiments, the combination is a combination of:
i) a composition comprising at least two different peptides, each peptide comprising one of SEQ ID NOs: 1-12, and
ii) a reference standard, preferably said standard being a United States Pharmacopeia (USP) reference standard or a standard comprising caffeine, acetaminophen, sulfadimethoxine, verapamil, reserpine, amitriptyline, naphthalene, butylparaben, uracil, sulfaguanidine, Val-Tyr-Val, leucine-enkephalin, terfenadine, or a salt thereof, more preferably comprising caffeine, acetaminophen, sulfadimethoxine, verapamil, reserpine, amitriptyline, naphthalene, butylparaben, uracil, or a salt thereof, most preferably comprising reserpine or a salt thereof.

### GENERAL DEFINITIONS

“Sequence identity” and “sequence similarity” can be determined by alignment of two peptide sequences using global or local alignment algorithms, depending on the length of the two sequences. Sequences of similar lengths are preferably aligned using a global alignment algorithm (e.g. Needleman-Wunsch) which aligns the sequences optimally over the entire length, while sequences of substantially different lengths are preferably aligned using a local alignment algorithm (e.g. Smith-Waterman). Sequences may then be referred to as “substantially identical” or “essentially similar” when they (when optimally aligned by for example the program EMBOSS needle or EMBOSS water using default parameters) share at least a certain minimal percentage of sequence identity (as described below). Reference to a SEQ ID NO is preferably reference to that SEQ ID NO over its entire length.

A global alignment is suitably used to determine sequence identity when the two sequences have similar lengths. When sequences have a substantially different overall length, local alignments, such as those using the Smith-Waterman algorithm, are preferred. EMBOSS needle uses the Needleman-Wunsch global alignment algorithm to align two sequences over their entire length (full length), maximizing the number of matches and minimizing the number of gaps. EMBOSS water uses the Smith-Waterman local alignment algorithm. Generally, the EMBOSS needle and EMBOSS water default parameters are used, with a gap open penalty =10 (nucleotide sequences)/10 (proteins) and gap extension penalty =0.5 (nucleotide sequences)/0.5 (proteins). For nucleotide sequences the default scoring matrix used is DNAfull and for proteins the default scoring matrix is Blosum62 (Henikoff & Henikoff, 1992, PNAS 89, 915-919).

Alternatively, percentage similarity or identity may be determined by searching against public databases, using algorithms such as FASTA, BLAST, etc. Thus, the protein sequences of some embodiments of the present invention can further be used as a “query sequence” to perform a search against public databases to, for example, identify other family members or related sequences. Such searches can be performed using the BLASTn and BLASTx programs (version 2.0) of Altschul, et al. (1990) J. Mol. Biol. 215:403-10. BLAST protein searches can be performed with the BLASTx program, score =50, wordlength =3 to obtain amino acid sequences homologous to protein molecules of the invention. To obtain gapped alignments for comparison purposes, Gapped BLAST can be utilized as described in Altschul et al., (1997) Nucleic Acids Res. 25(17): 3389-3402. When utilizing BLAST and Gapped BLAST programs, the default parameters of the respective programs (e.g., BLASTx and BLASTn) can be used.

In this document and in its claims, the verb “to comprise” and its conjugations is used in its non-limiting sense to mean that items following the word are included, but items not specifically mentioned are not excluded. In addition, the verb “to consist” may be replaced by “to consist essentially of” meaning that a composition as described herein may comprise additional component(s) than the ones specifically identified, said additional component(s) not altering the unique characteristics of the invention. In addition, the verb “to consist” may be replaced by “to consist essentially of” meaning that a method or use as described herein may comprise additional step(s) than the ones specifically identified, said additional step(s) not altering the unique characteristic of the invention. In addition, the verb “to consist” may be replaced by “to consist essentially of” meaning that a nucleotide or amino acid sequence as described herein may comprise additional nucleotides or amino acids than the ones specifically identified, said additional nucleotides or amino acids not altering the unique characteristics of the invention.

Reference to an element by the indefinite article “a” or “an” does not exclude the possibility that more than one of the element is present, unless the context clearly requires that there be one and only one of the elements. The indefinite article “a” or “an” thus usually means “at least one”.

As used herein, with “at least” a particular value means that particular value or more. For example, “at least 2” is understood to be the same as “2 or more” i.e., 2, 3, 4, 5, 6, 7, 8, 9, 10, 11, 12, 13, 14, 15, . . . , etc. Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. The word “about” or “approximately” when used in association with a numerical value (e.g. about 10) preferably means that the value may be the given value (of 10) more or less 10%, preferably 5%, more preferably 1% of the value.

Various embodiments are described herein. Each embodiment as identified herein may be combined together unless otherwise indicated. All patent applications, patents, and printed publications cited herein are incorporated herein by reference in their entireties. One skilled in the art will recognize many methods and materials similar or equivalent to those described herein, which could be used in the practice of the present invention. Indeed, the present invention is in no way limited to the methods and materials described.

TABLE 1
Utilized amino acid sequences

| SEQ | | |
|---|---|---|
| ID NO | Name | Sequence |
| 1 | Peptide 1 | DKCLKFYSKISEYRHYCYSLYGTTL |
| 2 | Peptide 2 | LYCYEQLNDSSEEEDEIDGPAGQAEPDRAHYNIVT |
| 3 | Peptide 3 | MHGDTPTLHEYMLDLQPETTDLYCYEQLNDSSEEE |
| 4 | Peptide 4 | RCINCQKPLCPEEKQRHLDKKQRFHNIRGRWT |
| 5 | Peptide 5 | TLRLCVQSTHVDIRTLEDLLMGTLGIVCPICSQKP |
| 6 | Peptide 6 | DKKQRFHNIRGRWTGRCMSCCRSSRTRRETQL |
| 7 | Peptide 7 | HYCYSLYGTTLEQQYNKPLCDLLIR |
| 8 | Peptide 8 | KQQLLRREVYDFAFRDLCIVYRDGN |
| 9 | Peptide 9 | LPQLCTELQTTIHDIILECVYCKQQLLRREVY |
| 10 | Peptide 10 | MHQKRTAMFQ QERPRKLPQLCTELQTTIHD |
| 11 | Peptide 11 | RDLCIVYRDGNPYAVCDKCLKFYSKI |
| 12 | Peptide 12 | YGTTLEQQYNKPLCDLLIRCINCQKPLCPEEK |

### DESCRIPTION OF THE FIGURES

FIG. 1—DP-5P mixture (5 peptides, SEQ ID NO: 1-5, indicated by numbers 1-5 respectively) UPLC-UV chromatogram in a conventional analytical method. The DP-5P mixture is represented by A, with B representing a blank solution.
FIG. 2—DP-7P mixture (7 peptides, SEQ ID NO: 6-12, indicated by numbers 6-12 respectively) UPLC-UV chromatogram in a conventional analytical method. The DP-7P mixture is represented by A, with B representing a blank solution.
FIG. 3—DP-5P mixture (5 peptides, SEQ ID NO: 1-5, indicated by numbers 1-5 respectively) UPLC-UV chromatogram in a method according to the invention.
FIG. 4—DP-7P mixture (7 peptides, SEQ ID NO: 6-12, indicated by numbers 6-12 respectively) UPLC-UV chromatogram in a method according to the invention.

### EXAMPLES

### Example 1. Determination of Peptide Content in a Mixture Comprising a Peptide

A mixture comprising an unknown quantity of a peptide (SEQ ID NO: 1) is provided A reference standard solution comprising 0.1 mg reserpine is further provided. The ratio of molar extinction coefficients is determined by calculation of the relative response factor between the peptide and reserpine, using Formula II. To calculate the relative response factor, the response factor of the peptide is first determined by measuring the absorbance of a peptide solution of known concentration at 220 nm, followed by dividing the measured absorbance by the known concentration of the peptide in said solution. The response factor of reserpine at 220 nm is similarly determined. The absorbance of the peptide in the mixture comprising the unknown quantity of said peptide and of reserpine in the reference standard solution is determined at 220 nm by UPLC-UV. The unknown quantity of the peptide in the mixture is then determined using Formula III.

### Example 2. Determination of Peptide Content in a Mixture Comprising Different Peptides Using a Conventional Analytical Method

### General

The purity including individual related substances and the assay of a DP-5P (5 peptides, SEQ ID NOs: 1-5) and DP-7P (7 peptides, SEQ ID NOs: 6-12) mixture were determined by reversed phase rapid HPLC (UPLC) using a mobile phase gradient of acetonitrile and water and UV detection at λ=220 nm.

### CHROMATOGRAPHIC CONDITIONS

Column: RP C18, e.g. Waters Acquity, BEH 130 PST (1.7 μm, 150×2.1 mm)
Sample matrix Eluent A : Eluent B=85:15 (v/v).
Sample concentration 100 μg/mL net peptide (of each drug substance mixture), duplicate
Injection volume: 5 μL
Column temperature: 65° C.
Sample temperature: 5° C.
Detection: UV (λ=220 nm)
Flow rate: 0.3 mL/min
Eluent A: 0.05%v/v TFA and 1%v/v Acetonitrile (ACN) in water
Eluent B: 0.05%v/v TFA in ACN

TABLE 2
Gradient for conventional analytical method

| Time (min) | Eluent A (% v/v) | Eluent B (% v/v) |
|---|---|---|
| 0 | 87 | 13 |
| 0.5 | 87 | 13 |
| 5.5 | 79.5 | 20.5 |
| 17.0 | 68 | 32 |
| 22.8 | 45 | 55 |
| 28.5 | 45 | 55 |
| 28.6 | 20 | 80 |
| 30.0 | 20 | 80 |
| 30.1 | 87 | 13 |
| 33.0 | 87 | 13 |

### Reporting

The relative retention times (RRTs) assigned to peptides and related substances both in a DP-5P (SEQ ID NO: 1-5) and DP-7P (SEQ ID NO: 6-12) mixture was calculated with reference to the retention time of the peptide eluting in the middle (FIG. 1 and FIG. 2). That retention time was used as reference as the main peak of this drug substance was detected approx. in the center of the chromatogram. The related substances were determined by area normalization. The individual related substances were reported≥0.10%a/a. The total related substances were calculated as the sum of all individual related substances equal to or greater than a disregard limit of 0.0500%a/a. The purity was calculated as the difference between total related substances and 100%.

The assay of each of the peptides was calculated against a reference standard solution containing either five peptides (DP-5P) or seven peptides (DP-7P) and was expressed in percent and in mg net peptide/vial. For this reference method, the absorption ratio between the reference substance and the analyte is 1, because the reference substance is the analyte itself.

### Example 3. Determination of Peptide Content in a Mixture Comprising Different Peptides Using an Analytical Method According to the Invention

### General

The UPLC method similar to Example 1 was used for the quantification of analytes (i.e. the individual peptides) in mixtures DP-5P (SEQ ID NO: 1-5) and DP-7P (SEQ ID NO: 6-12) and for the determination of content uniformity of mixtures DP-5P and DP-7P (lyophilized product). The method is based on the use of an external reference standard. The relative response factor (ratio of molar extinction coefficients, RRF) against this external reference standard has been established for each peptide. The purity, individual related substances, and the assay of DP-5P and DP-7P were determined by reversed phase rapid HPLC (UPLC) using a mobile phase gradient of ACN/IPA and water and UV detection at λ220 nm.

### Materials

The following lyophilized peptide compositions were used: DP-5P comprising peptides represented herein by SEQ ID NO: 1-5 admixed at equal net weights of 0.40 mg of each peptide per vial (total amount of protein per vial being 2.00 mg) and 0.56 mg TFA per vial; and DP-7P comprising peptides represented herein by SEQ ID NO: 6-12 admixed at equal net weights of 0.40 mg of each peptide per vial (total amount of protein per vial being 2.80 mg) and 0.96 mg TFA per vial. The following chemicals were used: Acetonitrile, (Biosolve, 01204102); UPLC water, (Type 1, milli-Q); trifluoroacetic acid, (Chem Lab, CLoo.2094.0001), 2-propanol, (UPLC/MS grade, Biosolve, 16264102); Reserpine, (USP, Sigma Aldrich, 1601000). The following equipment was used: QuanRecovery vials, (Waters, 186009186); UPLC pump equipped with a gradient system, autosampler, and UV detection (Waters Acquity or equivalent) and mixer volume 425 μL.

### Preparation of solvents and solutions:

Mobile phase A: 0.1% (v/v) TFA in water
Mobile phase B: 0.1% (v/v) TFA in 70/30 ACN/IPA
Diluent A: 0.05% (v/v) TFA in water
Diluent B: 0.05% (v/v) TFA in ACN
Blank solution: 80/20 (v/v) diluent A/diluent B
Purge solvent: 80/20 (v/v) water/ACN
Needle wash: 0.05% (v/v) TFA in 80/20 (v/v) water/ACN

### Stock reference solution (100 μg/mL Reserpine)

5.00 mg Reserpine reference material was accurately weighed and added into a 50 mL volumetric flask. 40.0 mL of blank solution was added, by means of a volumetric pipette. The solution was stirred for 10 min, by means of a magnetic stirrer, until fully dissolved. The solution was diluted to volume with blank solution and mixed well.

### Working reference solution (10 μg/mL Reserpine)

Transfer of 2.0 mL, by means of a volumetric pipette, of stock reference solution 1 into a 20 mL volumetric flask. Diluted to volume with blank solution and homogenized.

### LOQ solution (20 ng/mL Reserpine)

Transfer of 2.0 mL, by means of a volumetric pipette, of working reference solution 1 into a 100 mL volumetric flask. Diluted to volume with blank solution and homogenized. Transfer of 5 mL, by means of a volumetric pipette, of the above solution into a 50 mL volumetric flask. Diluted to volume with blank solution and homogenized.

### Sample Solution

This sample preparation was setup for lyophilized products DP-5P and DP-7P in an initially sealed container. Before opening and dissolving the drug product, the vials were equilibrated at room temperature for at least 1 hour. The content of the vial was dissolved with 0.8 mL of diluent B, and stirred for 20 min, using a magnetic stirrer. 3.2 mL of diluent A were added. The solution was stirred well for 20 min, using a magnetic stirrer. After dissolving the content of the vial, the sample vial was kept on the lab bench for 30 minutes. The solution was stirred briefly and transferred into an HPLC vial.

### Chromatographic Conditions

Column: Advance Bio Peptide Map (2.7 μm, 250 x 2.1 mm)
Sample matrix 0.05%v/v TFA in ACN : water (1:4 v/v)
Sample concentration 100 μg/mL net peptide (of each drug substance), duplicate
Injection volume: 10 μL
Column temperature: 40° C.
Sample temperature: 5° C.
Detection: UV (λ=220 nm)
Flow rate: 0.2 mL/min
Run time: 65 min
Purge solvent: 80/20 (v/v) water/ACN
Needle wash: 0.05% (v/v) TFA in 80/20 water/ACN (v/v) (20 s)
Seal wash: 90/10 (v/v) water/MeOH
Elution mode: Gradient elution
Eluent A: 0.1%v/v TFA in water
Eluent B: 0.1%v/v TFA in ACN/IPA (70:30 v/v)

TABLE 3
Gradient for analytical method according to the invention

| Time (min) | Eluent A (% v/v) | Eluent B (% v/v) |
|---|---|---|
| 0 | 80 | 20 |
| 1 | 80 | 20 |
| 50 | 35 | 65 |
| 50.1 | 1 | 99 |
| 55 | 1 | 99 |
| 55.1 | 80 | 20 |
| 65 | 80 | 20 |

TABLE 4
Injection sequence

| | Injec- | |
|---|---|---|
| | tions | |
| Solution | (#) | Acceptance criteria |
| Blank | min. 2 | Blank peaks preferably absent or if present, |
| solution | | preferably separated from the peptides and |
| | | all related impurities |
| LOQ solution | 1 | S/N ≥ 10 |
| Identification | 1 | The chromatogram is visually comparable with |
| solution | | the example chromatogram in the method |
| Working | 1 | Recovery towards mean injections (n = 5) of |
| reference | | working reference solution 1: 98.0%-102.0% |
| solution 2 | | |
| Working | 5 | RSD on area: % RSD(n = 5) ≤ 1.0 |
| reference | | |
| solution 1 | | |
| Sample | 1 | Maximum 12 sample injections between |
| solutions | | reference solutions |
| Control | 1 | Recovery towards mean injections (n = 5) of |
| working | | working reference solution 1: 98.0%-102.0% |
| reference | | |
| solution 1 | | |

### Relative Response Factor (RRF)

The RRF was determined for all 12 peptides, enabling the quantification of each peptide against a reserpine as shown above. For the determination, the absorbance of each peptide in a solution comprising said peptide at a known concentration, and of a reference standard solution comprising reserpine at a known concentration, were measured at 220 nm. Response factors for each peptide and for reserpine were determined as described above, by dividing the measured absorbance by the known concentration value (Table 5). The relative response factor was then determined using Formula II.

$$R R F = \frac{R {F}_{peptide}}{R {F}_{reserpine}} , \qquad Formula II$$

TABLE 5
Absorbance at 220 nm, concentration of measured solutions and relative response
factors (RRFs) between each peptide and reserpine

| Compound | Response (μV*sec) | Concentration (mg/mL) | RF $( \frac{Response}{Concentration} )$ | RRFᵣₑₛₑᵣₚᵢₙₑ $( \frac{{RF}_{peptide}}{{RF}_{reserpine}} )$ |
|---|---|---|---|---|
| Reserpine | 3001390 | 0.0099 | 303275005 | N/A |
| Peptide 6 (SEQ ID NO 6) | 4396082 | 0.0974 | 45122916 | 0.148 |
| Peptide 7 (SEQ ID NO 7) | 5164489 | 0.1019 | 50692679 | 0.165 |
| Peptide 8 (SEQ ID NO 8) | 3476444 | 0.0966 | 36004134 | 0.116 |
| Peptide 9 (SEQ ID NO 9) | 3353840 | 0.0984 | 34092402 | 0.110 |
| Peptide 10 (SEQ ID NO 10) | 3068353 | 0.0994 | 30878932 | 0.101 |
| Peptide 11 (SEQ ID NO 11) | 4455737 | 0.1011 | 44066034 | 0.146 |
| Peptide 12 (SEQ ID NO 12) | 3376228 | 0.1009 | 33453703 | 0.108 |
| DP-5P | Response (μV*sec) | Concentration (mg/mL) | RF $( \frac{Response}{Concentration} )$ | RRFᵣₑₛₑᵣₚᵢₙₑ $( \frac{{RF}_{peptide}}{{RF}_{reserpine}} )$ |
| Reserpine | 3166278 | 0.0104 | 304008664 | N/A |
| Peptide 1 (SEQ ID NO 1) | 5901793 | 0.1019 | 57907269 | 0.190 |
| Peptide 2 (SEQ ID NO 2) | 3781376 | 0.0986 | 38358917 | 0.125 |
| Peptide 3 (SEQ ID NO 3) | 3852495 | 0.0974 | 39571863 | 0.132 |
| Peptide 4 (SEQ ID NO 4) | 5030590 | 0.0995 | 50537361 | 0.168* |
| Peptide 5 (SEQ ID NO 5) | 2258101 | 0.1019 | 22169413 | 0.073 |

Note:
*A different reserpine solution was used for the determination of the RRF, this solution has an RF of 301932379

### Assay calculation

The content of each peptide in each analysis was determined using a single level external standard method with working reference solution 1. The formula to calculate the content of an individual peptide per vial was adapted from Formula III as follows.

$$Assay ( mg peptide / vial ) = \frac{{A}_{SLP} \times {Q}_{RS} \times {P}_{RS} \times DF}{{A}_{RS} \times {Q}_{S} \times RRF}$$

A_{SLP}: Response of individual peptide (area) (SLP stands for peptide solution)
A_{RS}: Average response Reserpine (RS) in the 5 injections of the working reference solution 1 (area)
Q_{RS}: Quantity of Reserpine in working reference solution 1 (mg)
Q_{S}: Quantity of the DP: 1 (vial)
P_{RS}: Purity of Reserpine (RS) (expressed in ratio of 1, e.g. 0.99)
DF: Dilution factor of the SLP-solution

$$D F = \frac{{V}_{SLP}}{{V}_{stock solution RS} \times D {F}_{1}} = 0.008$$

$${V}_{SLP} = volume used to dissolve the content of the vial ( = 4 mL )$$

$${V}_{stock solution RS} = volume of stock reference solution ( = 50 mL )$$

$$D {F}_{1} = Dilution factor of the stock reference solution \\ to obtain working reference solution ( = 10 )$$

RRF: Relative response factor between Reserpine and SLP (ratio of response factors, shown in Table 5)

### Reporting

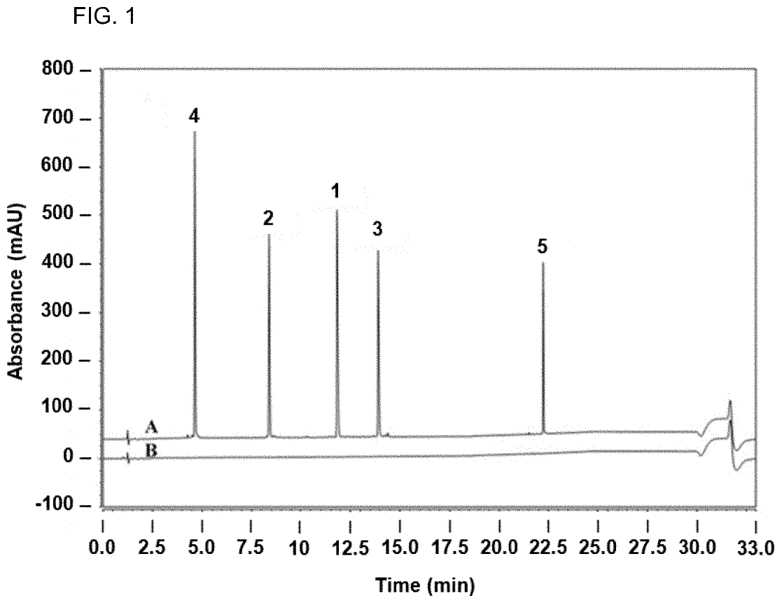

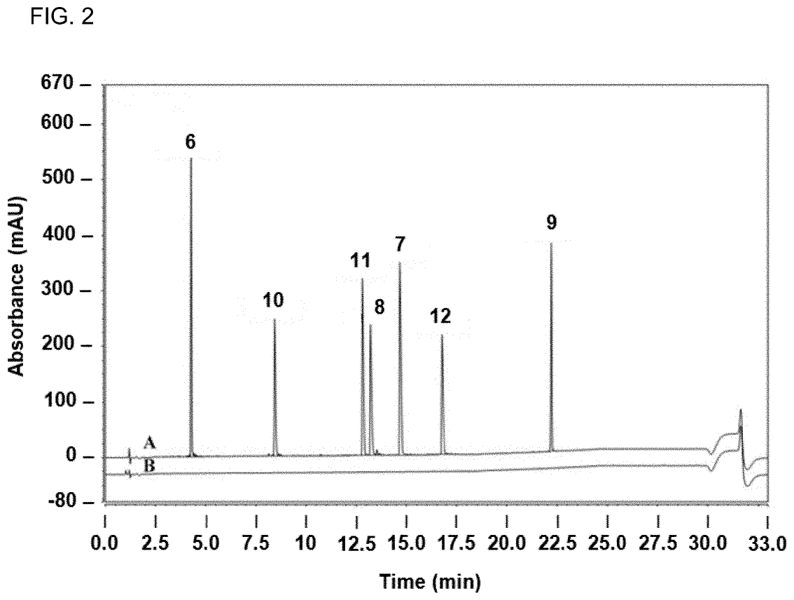

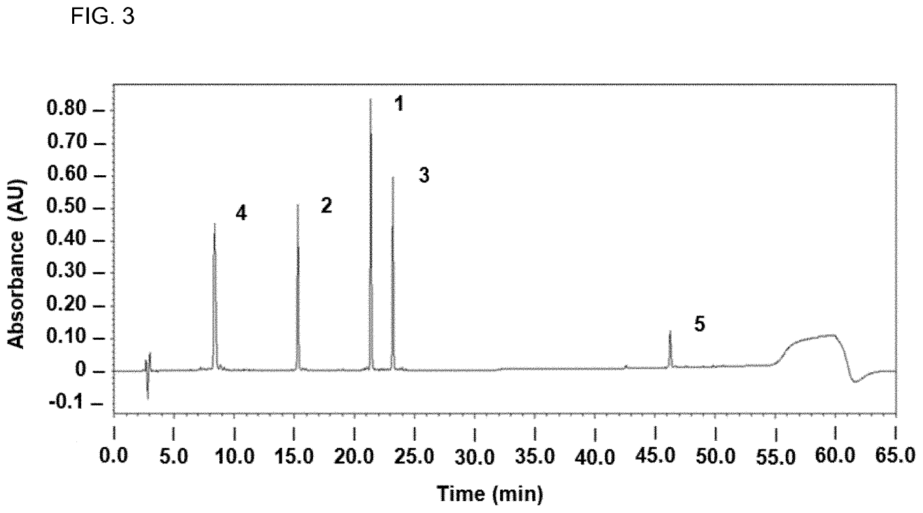

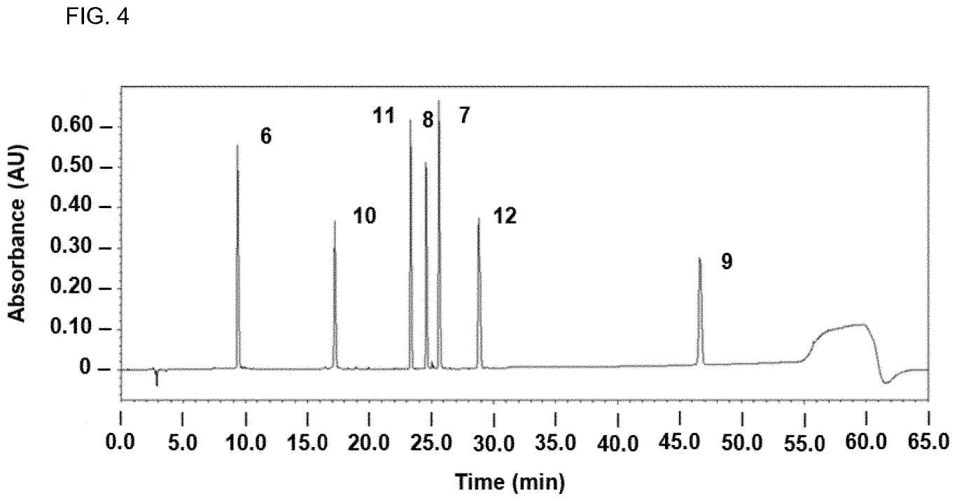

The relative retention times (RRTs) assigned to peptides and related substances in both DP-5P and DP-7P were calculated with reference to the retention time of the peptide eluting in the middle (FIG. 3 and FIG. 4). That retention time was used as reference as the main peak of this drug substance is detected approx. in the center of the chromatogram. The related substances were determined by normalization of the total response.

The individual related substances are reported ≥0.10%w/w. The total related substances were calculated as the sum of all individual related substances equal to or greater than a disregard limit of 0.05%w/w. The purity was calculated as the difference between total related substances and 100%w/w. The assay of each of the drug substances is calculated against the USP reference standard reserpine and is expressed in mg net peptide/vial.

### Example 4. Exemplary Peptide Content Determination and Calculation

For the analysis the following solutions/ samples are prepared and injected according to the method:
I. Reference solution
   1) A stock solution is prepared from 5.08 mg Reserpine in 50 mL.
   2) 2 mL of the stock is diluted to a total of 20 mL (dilution factor (DF,) =10)
   The purity of reserpine is taken from its CoA: 98.2% (purity factor 0.982)
   The mean response over 5 injections is 3088845 μV*sec
II. The sample solution:
   1) One vial that contains approximately 0.4 mg of each peptide present in DP-5P is dissolved in 4 mL
   2) The response for peptide 4 (SEQ ID NO. 4) for injection is 4984380 μV*sec
III. The dilution factor (DF) for the solution of peptide 4 (SEQ ID NO. 4) is calculated as follows:

$$D F = \frac{{V}_{SLP}}{{V}_{stock solution RS} \times D {F}_{1}} = \frac{4}{50 \times 10} = 0.008$$

IV. Now the assay for peptide 4 (SEQ ID NO. 4) can be calculated by filling out formula III:

$$Assay peptide \#4 = \frac{{A}_{SLP} \times {Q}_{RS} \times {P}_{RS} \times DF}{{A}_{RS} \times {Q}_{S} \times {RRF}_{peptide 4 / reserpine}} = \frac{4984380 \times 5.08 \times 0.982 \times 0.008}{3088845 \times 1 \times 0.168} = 0.38 mg / vial$$

### Example 5. Improved Results are Obtained with a Method of the Invention

### DP-5P

The DP-5P batch shown in Table 6 was manufactured by combining 5 separate peptides in solution in a 1:1 ratio each. Subsequently the solution of filled in vials was lyophilized, ending up with a vial that contained 0.400 mg of each of the peptides (i.e. 2.00 mg in total). The content of each of the peptides can be expressed in several ways, amongst which the actual amount present in a vial in mg or the percentage of the amount in relation to the manufacturing target of 0.400 mg per vial.

At T=0 months (TOM) the peptide content was measured using the conventional method of Example 2. From T=48 months (T48M) onwards the peptide content was measured with the conventional method of Example 2 and the method according to the invention of Example 3. The results are shown in Table 6:

TABLE 6
Comparison of data from the same DP-5P batch

| | | | | | Method according to the | | |
|---|---|---|---|---|---|---|---|
| | Conventional method (peptide as RS) | | | | invention (USP RS) | | |
| Identity | T0M | T48M | T54M | T60M | T48M | T54M | T60M |

Label claim (% target 0.40 mg/vial)

| | | | | | | | |
|---|---|---|---|---|---|---|---|
| Peptide 4 (SEQ ID NO 4) | 98% | 98% | 98% | 98% | 96% | 99% | 96% |
| Peptide 2 (SEQ ID NO 2) | 102% | 104% | 104% | 104% | 99% | 98% | 97% |
| Peptide 1 (SEQ ID NO 1) | 101% | 103% | 102% | 102% | 98% | 98% | 93% |
| Peptide 3 (SEQ ID NO 3) | 99% | 108% | 105% | 104% | 95% | 95% | 97% |
| Peptide 5 (SEQ ID NO 5) | 99% | 103% | 99% | 100% | 101% | 101% | 99% |

Assay (mg/vial)

| | | | | | | | |
|---|---|---|---|---|---|---|---|
| Peptide 4 (SEQ ID NO 4) | 0.3936 | 0.3937 | 0.3911 | 0.3913 | 0.3820 | 0.3966 | 0.3842 |
| Peptide 2 (SEQ ID NO 2) | 0.4085 | 0.4141 | 0.4149 | 0.4174 | 0.3950 | 0.3932 | 0.3880 |
| Peptide 1 (SEQ ID NO 1) | 0.4047 | 0.4107 | 0.4088 | 0.4082 | 0.3910 | 0.3932 | 0.3701 |
| Peptide 3 (SEQ ID NO 3) | 0.3942 | 0.4311 | 0.4194 | 0.4170 | 0.3798 | 0.3789 | 0.3883 |
| Peptide 5 (SEQ ID NO 5) | 0.3976 | 0.4107 | 0.3948 | 0.4011 | 0.4028 | 0.4021 | 0.3968 |
| Total net peptide | 1.9986 | 2.0603 | 2.0290 | 2.0350 | 1.9506 | 1.9641 | 1.9274 |

### DP-7P

The DP-7P batch shown in Table 7 manufactured by combining 7 separate peptides in solution in a 1:1 ratio each. Subsequently the solution of filled in vials was lyophilized, ending up with a vial that contained 0.400 mg of each of the peptides (i.e. 2.80 mg in total). The content of each of the peptides can be expressed in several ways, amongst which the actually amount present in a vial in mg or the percentage of the amount in relation to the manufacturing target of 0.400 mg per vial.

At T=0 months (TOM) the peptide content was measured using the conventional method of Example 2. From T=48 months (T48M) onwards the peptide content was measured with the conventional method of Example 2 and the method according to the invention of Example 3. The results are shown in Table 7:

TABLE 7
Comparison of data from the same DP-7P batch

| | | | | | Method according to the | | |
|---|---|---|---|---|---|---|---|
| | Conventional method (peptide as RS) | | | | invention (USP RS | | |
| Identity | T0M | T48M | T54M | T60M | T48M | T54M | T60M |

Label claim (% target 0.40 mg/vial)

| | | | | | | | |
|---|---|---|---|---|---|---|---|
| Peptide 6 (SEQ ID NO 6) | 108% | 110% | 107% | 107% | 103% | 101% | 100% |
| Peptide 10 (SEQ ID NO 10) | 105% | 108% | 107% | 109% | 101% | 99% | 99% |
| Peptide 11 (SEQ ID NO 11) | 106% | 107% | 105% | 105% | 97% | 95% | 95% |
| Peptide 8 (SEQ ID NO 8) | 109% | 108% | 107% | 107% | 99% | 98% | 98% |
| Peptide 7 (SEQ ID NO 7) | 107% | 107% | 105% | 106% | 101% | 99% | 99% |
| Peptide 12 (SEQ ID NO 12) | 107% | 108% | 105% | 105% | 103% | 101% | 100% |
| Peptide 9(SEQ ID NO 9) | 108% | 108% | 107% | 109% | 98% | 93% | 93% |

Assay (mg/vial)

| | | | | | | | |
|---|---|---|---|---|---|---|---|
| Peptide 6 (SEQ ID NO 6) | 0.4315 | 0.4390 | 0.4280 | 0.4286 | 0.4100 | 0.4033 | 0.4010 |
| Peptide 10 (SEQ ID NO 10) | 0.4212 | 0.4329 | 0.4271 | 0.4362 | 0.4060 | 0.3966 | 0.3945 |
| Peptide 11 (SEQ ID NO 11) | 0.4235 | 0.4293 | 0.4192 | 0.4209 | 0.3866 | 0.3815 | 0.3788 |
| Peptide 8 (SEQ ID NO 8) | 0.4357 | 0.4323 | 0.4289 | 0.4294 | 0.3980 | 0.3928 | 0.3900 |
| Peptide 7 (SEQ ID NO 7) | 0.4393 | 0.4279 | 0.4219 | 0.4222 | 0.4036 | 0.3980 | 0.3967 |
| Peptide 12 (SEQ ID NO 12) | 0.4261 | 0.4323 | 0.4215 | 0.4219 | 0.4132 | 0.4034 | 0.4010 |
| Peptide 9 (SEQ ID NO 9) | 0.4328 | 0.4325 | 0.4262 | 0.4361 | 0.3901 | 0.3718 | 0.3700 |
| Total net peptide | 3.0101 | 3.0262 | 2.9728 | 2.9953 | 2.8074 | 2.7473 | 2.7320 |

### Assessment

Several facts can be considered:
From a manufacturing perspective values that are higher than the target of 0.4 mg per vial are not expected; and similarly a value higher than 2.0 mg (DP-5P) and 2.8 mg (DP-7P) is not expected. The manufacturing process warrants the amount of peptide-input per peptide is according to the target; if any, results expected might be slightly lower due to e.g. potential of adsorption to filter or other surface. Therefore values over 100% have a higher probability of not being accurate, while values under 100% do not have this issue.
From a stability perspective assay values are not expected to increase over time, but rather decrease due to potential degradation taking place over time. Values that increase over time have a higher probability of not being accurate.
Per peptide a trend can exist in level over time, presenting a downwards level. In general it is not to be expected that levels increase (other than slightly due to method variability) or that values do not present a trend (e.g. values alternately increasing and decreasing over time).

As illustrated by the results (and summary in Table 8) the method of the invention shows significantly improved quantification over the conventional method.

TABLE 8
Comparison of results and their variation by both methods for DP-5P and DP-7P

| | | DP-5P | | DP-7P | |
|---|---|---|---|---|---|
| | | | Method | | Method |
| | Target | Conventional | according to | Conventional | according to |
| Variation | value | method | invention | method | invention |
| 48M Individual | 100 | 98-108 | 95-101 | 107-110 | 98-103 |
| peptides assay | | | | | |
| (% label claim) | | | | | |
| Individual peptides | 0.4000 | 0.3911-0.4311 | 0.3701-0.4028 | 0.4192-0.4390 | 0.3700-0.4132 |
| assay (mg/vial) | | | | | |
| Total peptides | 2.000 | 1.9986-2.0603 | 1.9274-1.9506 | | |
| assay (mg/vial) | 2.800 | | | 2.9728-3.0101 | 2.7473-2.8074 |

1. Method for producing a mixture comprising a known quantity of a first analyte, the method comprising the steps of:
i) providing a mixture comprising the first analyte;
ii) providing a reference standard comprising a known amount of a reference substance, wherein the reference substance is not the first analyte, wherein the reference substance is a small molecule, and wherein the ratio between the molar extinction coefficient of the first analyte and the molar extinction coefficient of the reference substance is known;
iii) determining the absorbance of the first analyte and of the reference substance using spectrophotometry to obtain values for first analyte absorbance and for reference substance absorbance; and
iv) determining the content of the first analyte in the mixture based on the obtained absorbance values and the known ratio of molar extinction coefficients.

2. The method according to claim 1, wherein the first analyte is a peptide, preferably wherein the first analyte is a peptide having a length from 5 to 100 amino acids.

3. The method according to claim 1, wherein the first analyte is a peptide comprising a sequence represented by any one of SEQ ID NOs: 1-12.

4. The method according to claim 1, wherein the mixture provided in step i) is a UV-transparent solution.

5. The method according to claim 1, wherein the mixture provided in step i) comprises the first analyte and solvents, wherein the solvents are preferably selected from water, isopropyl alcohol, and acetonitrile, and wherein optionally an acid is present such as formic acid or trifluoroacetic acid.

6. The method according to claim 1, wherein the mixture further comprises a second analyte and optionally a third, fourth, fifth, sixth, seventh, eighth, ninth, tenth, eleventh, twelfth, thirteenth, fourteenth, or fifteenth analyte, preferably wherein the ratios between the molar extinction coefficients of each analyte and the molar extinction coefficient of the reference substance are known.

7. The method according to claim 6, wherein the absorbance of each analyte is determined in step iii), and wherein the content of each analyte is determined in step iv).

8. The method according to claim 1, wherein step iii) is performed using analytical liquid chromatography, such as HPLC or UPLC, and wherein optionally step iii) comprises the following sub-steps:
iii-a) adding a known amount of reference substance to the mixture;
iii-b) separating the first analyte and the reference substance using liquid chromatography;
iii-c) determining the absorbance of the first analyte and of the reference substance using spectrophotometry to obtain values for first analyte absorbance and for reference substance absorbance.

9. The method according to claim 1, wherein the molar extinction coefficient of a reference substance and/or analyte is the molar extinction coefficient determined at a wavelength from 180 to 800 nm.

10. The method according to claim 1, wherein the reference substance has a molar extinction coefficient of from 0.1·10⁴ L·mol⁻¹·cm-⁻¹ to 3·10⁴ L·mol⁻¹·cm⁻¹.

11. The method according to claim 1, wherein the reference standard is a United States Pharmacopeia (USP) reference standard.

12. The method according to claim 1, wherein the reference standard is a standard comprising caffeine, acetaminophen, sulfadimethoxine, verapamil, reserpine, amitriptyline, naphthalene, butylparaben, uracil, sulfaguanidine, Val-Tyr-Val, leucine-enkephalin, terfenadine, or a salt thereof, preferably comprising caffeine, acetaminophen, sulfadimethoxine, verapamil, reserpine, amitriptyline, naphthalene, butylparaben, uracil, or a salt thereof, more preferably comprising reserpine or a salt thereof.

13. A composition comprising at least four different peptides as defined in claim 3, wherein the weight percentage of each peptide is from 93% to 103% of the average weight percentage of all different peptides.

14. A plurality of compositions comprising at least a first composition and a second composition, wherein the first and the second composition are each a composition according to claim 13, wherein the composition differ from each other in that the compositions originate from different production batches, wherein the weight percentage of each peptide comprised in the first composition is from 93% to 103% of the weight percentage of that same peptide as comprised in the second composition,
wherein preferably the compositions comprise one of: DP-5P) five different peptides, each peptide comprising one of SEQ ID NOs: 1-5; or DP-7P) seven different peptides, each peptide comprising one of SEQ ID NOs: 6-12.
